(19) United States
(12) Patent Application Publication
(10) Pub. No.: US 2006/0088152 A1
(43) Pub. Date: Apr. 27, 2006

(54) Conference-call initiation

(75) Inventors: Thomas J. Green, San Leandro, CA (US); Tod W. Irwin, San Jose, CA (US); Donald J. Pilcher, Half Moon Bay, CA (US); John R. Rose, San Jose, CA (US); Herbert C. Spenner, San Jose, CA (US); Kevin M. Thornton, Danville, CA (US); Roger D. Wiens, San Jose, CA (US)

Correspondence Address: FOLEY HOAG, LLP;PATENT GROUP, WORLD TRADE CENTER WEST, 155 SEAPORT BLVD, BOSTON, MA, 02110, US

(73) Assignee: Lightbridge, Inc., Burlington, MA (US)

(21) Appl. No.: 10/969,897

(22) Filed: Oct. 21, 2004

(51) Int. Cl. H04M 3/42; H04Q 11/00; H04L 12/16

(52) U.S. Cl. 379/202.01; 379/88.17; 370/261

(57) ABSTRACT

In response to a request for a conference call among specified invitees, a conference-call system provides web pages that elicit from respective invitees the telephone numbers at which they can be reached, and it causes messages that contain those web pages' URIs to be sent to those invitees. If a presence network indicates that an invitee's messages will be received on a telephone, the conference system instead sends to that phone a message specifying a telephone number to call and a PIN to be used for that purpose.

### BACKGROUND OF THE INVENTION

1. Field of the Invention

The present invention concerns conference calling and in particular deals with ways in which conference calls are initiated.

2. Background Information

Voice conferencing enables groups to collaborate efficiently and effectively. When members of a group are in different locations, a voice conference is often the fastest, least expensive, and most convenient way to collaborate. Access to a telephone is the only prerequisite for joining a conference. As a consequence, conference-calling services have enjoyed some popularity.

But their popularity has not reached the level that conference calling's benefits would seem to justify. Part of the reason is that setting up conference calls is complex. In one approach to conference-call initiation, known as “dial in” approach, the participants call a specific telephone number and enter an access code associated with the conference. For this to happen, someone needs to communicate the conference number and access code to all participants ahead of time. That requirement tends to discourage the use of conference-calling services for ad hoc conferences. In another, “dial-out” approach, the conferencing service places the call to the participant. After the participant answers the call and indicates that he wants to join, the service connects the participant into the conference. Although this approach avoids the need to send conference-service particulars in advance to prospective participants, it imposes the need to know and collect beforehand the telephone numbers at which the service will be able to reach them. This, too, tends to inhibit ad hoc conferencing. In some types of conferences, moreover, it tends to discourage participation; participants in some conferences prefer to withhold their locations and even their identities.

Recognizing the burden placed on a conference host, many conferencing services provide tools to make the process of scheduling or initiating a conference more convenient. Many of these tools enable the host to select from a list of potential participants and automatically send notifications or invitations to the invitees.

### SUMMARY OF THE INVENTION

But we have recognized that such tools leave room for improvement. In accordance with one aspect of the invention, the conferencing system causes an invitee to be invited to direct his browser to a web page that elicits a telephone number at which he can be reached. The message by which that invitation is extended can be sent, for example, through an Internet link, and preferably by a mechanism, such as instant messaging (“IM”), that tends to evoke a rapid response and can be so automated as to send messages to several invitees simultaneously. So using this approach can eliminate the need for participants to know too far ahead of time the telephone numbers at which they can be reached.

Now, employing that aspect of the invention requires the invitee to be present at his computer or similar device so that he can receive the message and enter his telephone number. But another aspect of the invention relaxes this requirement. According to that other aspect, the type of apparatus on which the invitee receives messages is determined. If the apparatus is a telephone, the invitee is instead sent a number to call in order to join the conference; that invitee will call in rather than have the conference service call out.

### BRIEF DESCRIPTION OF THE DRAWINGS

The invention description below refers to the accompanying drawings, of which:

FIG. 1 is a block diagram of a conference-calling system shown in an exemplary environment; and

FIG. 2 is a flow chart of an exemplary routine for processing lists of invitees to a conference call.

### DETAILED DESCRIPTION OF AN ILLUSTRATIVE EMBODIMENT

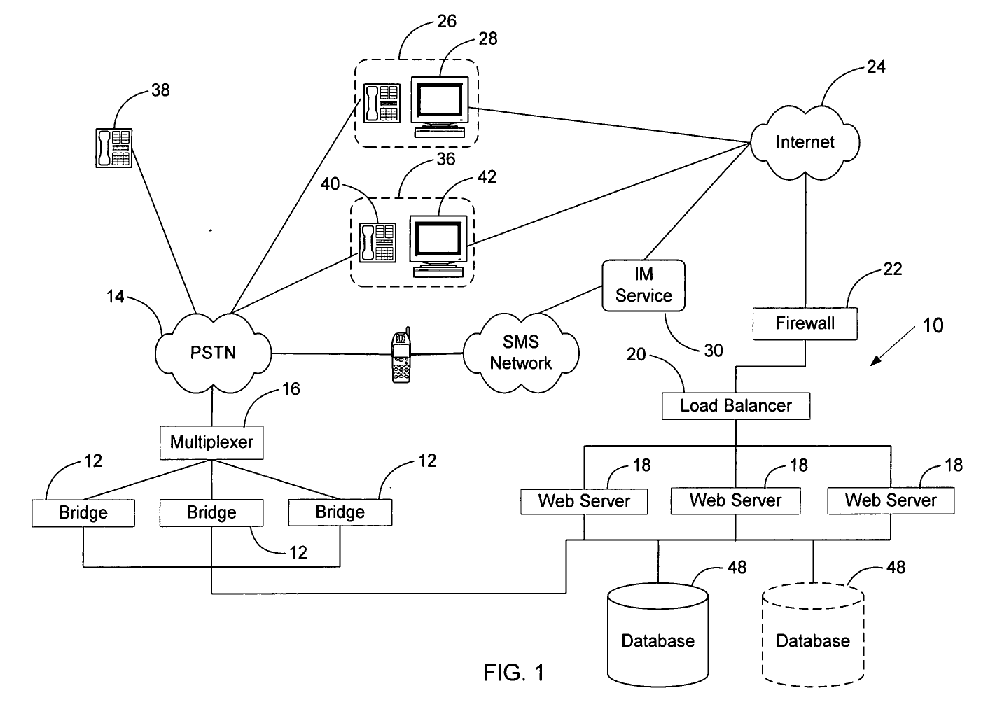

FIG. 1 depicts a conference-calling system 10 in an exemplary environment. That system includes conferencing bridges 12 operable to set up conference calls over the public switched telephone network (“PSTN”) 14 through a multiplexer 16. Although the conferencing bridges 12 are shown as providing connections only through the PSTN, bridges in some embodiments may instead or additionally implement conferences through other media. For instance, they may employ voice-over-Internet-Protocol (“VoIP”) connections, which may use a Session Initiation Protocol (“SIP”) network address. The illustrated conferencing system also includes web servers 18 that respond to requests distributed to them by a load balancer 20. The load balancer 20 receives the requests in turn through a firewall 22 from the Internet 24. In the illustrated embodiment, the web servers 18 are embodied in computer systems that are configured by instructions stored on a disk drive or other storage medium to act not only as web servers but also as part of the control circuitry required to provide additional conferencing-system features described below. The circuitry that implements the illustrated embodiment's conferencing bridges 12 also acts as part of that control circuitry. In other embodiments, the bridges and servers may be implemented in the same processor or other circuitry, which may additionally act as the control circuitry. Or the control functions may be provided instead or additionally by circuitry separate from the web servers and the bridges, and the functions may be hard-wired instead of software-configured.

To initiate a conference call, a user located at, say, location 26 first submits a conference-call request to the conference-calling system 10. Since the invention has particular advantages for ad hoc conferencing, it will be implicit in most embodiments that the conference is to be started as soon as possible, but some embodiments may enable the conference-initiating user, whom we refer to here as the “conference host,” to set some later start time. Although one way of starting a conference in some embodiments may be for the conference host to place a telephone call to the conference-calling service and request the conference, a more typical way will be for the conference host to use an instant-messaging client on his computer 28 or direct his browser to a conference-service web site through which the request can be made.

In addition to making the request, the conference host will typically select conference invitees. Although other embodiments may use different approaches to identifying invitees, many will take advantage of instant-messaging or other presence-network services. Instant-messaging services provide a mechanism for more-or-less immediate communication among parties who are on line simultaneously. Associated with instant-messaging clients are respective contact lists, i.e., lists of other parties with whom the instant-messaging client's user is likely to employ that client to communicate. An instant-messaging client notifies an instant-messaging service 30 (such as the ICQ, AOL Instant Messenger, MSN Messenger, and Yahoo Messenger services) that the client's user is on line, and it may also send that service other information, such as the type of apparatus on which the user is receiving instant messages. It may indicate, for instance, that the apparatus on which the user is currently receiving instant messages is a telephone rather than a desktop or laptop workstation. In any event, by collecting such information from that client and others, the instant-messaging service can let those clients' users know which parties on their instant-messaging contact lists are currently on line. And some embodiments may similarly use other types of presence-network technology, such as Finger, SIP, and XMPP, to obtain such connection-state information.

The conferencing system can use such information to facilitate invitee selection. Specifically, the system can automatically retrieve the conference host's list of instant-messaging contacts and have the host select from among some or all of the list's entries. This can be done in a number of ways. The illustrated embodiment, for example, employs an instant-messaging client on the conference host's computer for this purpose. It responds to the conference host's request by sending the conference host's browser a web page. The web page directs the conference host's browser to execute programming that among other things collects a list of instant-messaging contacts from the conference host's computer and displays some or all of those contacts on the web page that the conference host sees. That programming can be thought of as a conference-calling client and may, for example, take the form of JavaScript instructions included in the web page or retrieved from a location to which the web page refers. In other embodiments, the instant-messaging client itself may include such a conferencing client, or the conference host's computer may in some other way contain a conferencing client without needing to receive it from the conferencing system for each request.

In collecting the contact information, the illustrated embodiment's conference-calling client takes advantage of the fact that instant-messaging clients' application-programming interfaces (“APIs”) may expose subroutines that can be invoked to retrieve such contact information. Instead of using the conference host's instant-messaging client, some embodiments may query the instant-messaging service directly or through an instant-messaging “robot.” In any event, a web page can display the information thereby retrieved and invite the conference host to select invitees from the contact list. In some embodiments that employ instant-messaging clients, the conference-calling client may additionally retrieve the contacts' connection-state information. It may, for example, display this information to the conference host and/or use it to refrain from displaying contact-list members who are not currently on line.

Now, the conferencing client may not require that the conference host make an invitee selection explicitly. For example, the host's instant-messaging or conferencing client may in some fashion maintain a default list that the conferencing client sends in the absence of an explicit choice. Similarly, the conference-calling center may maintain default lists for its customers, and, if the conferencing client specifies no explicit invitee selection, adopt the members of that default list as the invitees. If the conference host does respond by selecting invitees from among the displayed contacts, though, the conferencing client will send that selection to the conference-calling system. In doing so, the illustrated embodiment identifies the selected invitees by their instant-messaging aliases. We will assume that expedient in the description below, although other embodiments of the invention may use other types of invitee identifiers.

In any case, the conference-calling system then needs to send the invitees their conference invitations. As will be explained below, the way in which some embodiments extend the invitation to a particular invitee will depend on the type of apparatus on which that invitee is receiving his instant messages. But we will first consider the simple situation in which the instant-messaging client has identified all selected invitees as being present at their personal computers—as opposed to, say, their IM-capable telephones, to which some instant-messaging services sometimes deliver messages. In this situation, the way in which the conference-calling system will join invitees to the conference after they have accepted in the manner described below is to place calls to them rather than have them place calls to it. (In other situations, as will be explained below, the illustrated embodiment instead permits the invitee to place the call.)

For some invitees, the conference-calling system may have stored telephone numbers. It may, for example, have associated telephone numbers with those invitees' instant-messaging aliases in response to input that they have provided previously. Furthermore, certain of those invitees may have provided the system “auto-accept” lists, which constitute blanket authorizations to call those invitees for any conference initiated by someone belonging to their respective lists. To those invitees, the conference-calling system can simply place calls without obtaining acceptances or eliciting telephone numbers anew. In some cases, such an invitee may have given the service more than one telephone number. An invitee at location 36, for example, may have listed the number of a remote telephone set 38 in addition to the number of the phone 40 located near his computer 42. If so, the service may call those numbers simultaneously, or it may call them consecutively until it either reaches the invitee or runs out of numbers.

In most cases, though, the conference-calling system will need to obtain the invitees' acceptances and the telephone numbers at which they can be reached. (As was mentioned above, the calls are not necessarily PSTN calls, so the elicited telephone number may not be a PSTN number. It may instead be the network name and/or address of a net-work-based phone; it may be the SIP address of a VoIP phone, for example.) The system elicits those acceptances and telephone numbers through web pages that it sets up on its web server, and it causes the invitees to be sent those web pages' universal resource identifiers (“URIs”).

One way of sending the URIs is for the conference-calling system to do so directly, in an instant message. More typically, though, the conference-calling system will instead send the conference host's browser a web page that includes further programming. That programming directs the conference host's instant-messaging client to send instant messages containing the URIs to the invitees, of which the drawing represents one as being situated at location 36. The web page may additionally display information by which the conference host can monitor the conference status.

When the invitees receive their instant messages, they typically direct their browsers to the web pages that the URIs identify. Separate such web pages can be statically stored for respective invitees and associated with those invitees' instant-messaging aliases or other invitee identifiers. In most embodiments, though, the URIs will include parameters that the web-server software uses to create invitee-specific web pages dynamically. Among the parameters may, for example, be an identifier, such as a universally unique identifier, that the service uses for that invitee and session only and never uses again.

Independently of how the web pages are created, they elicit telephone numbers and, at least implicitly, invitation acceptances. To indicate his acceptance, the invitee typically enters into a web-page input window the telephone number at which he can be reached and selects a button that triggers the web-page's programming to send that number to the conference-calling system. The reason why the web pages sent to the invitees are invitee-specific in the illustrated embodiment is that they can thereby contain information that identifies the invitee and conference. In sending the user's response to the conferencing system, the web-page programming can then include that information without the user's having been required to enter it.

When the conference-calling system has received the telephone numbers (and thereby the acceptances), it operates one of its conferencing bridges 12 to send calls to the invitee-supplied telephone numbers, typically over the PSTN 14. Alternatively, some of the calls could be made over the Internet by, e.g., voice over Internet Protocol (“VoIP”). The conference then proceeds in a conventional manner.

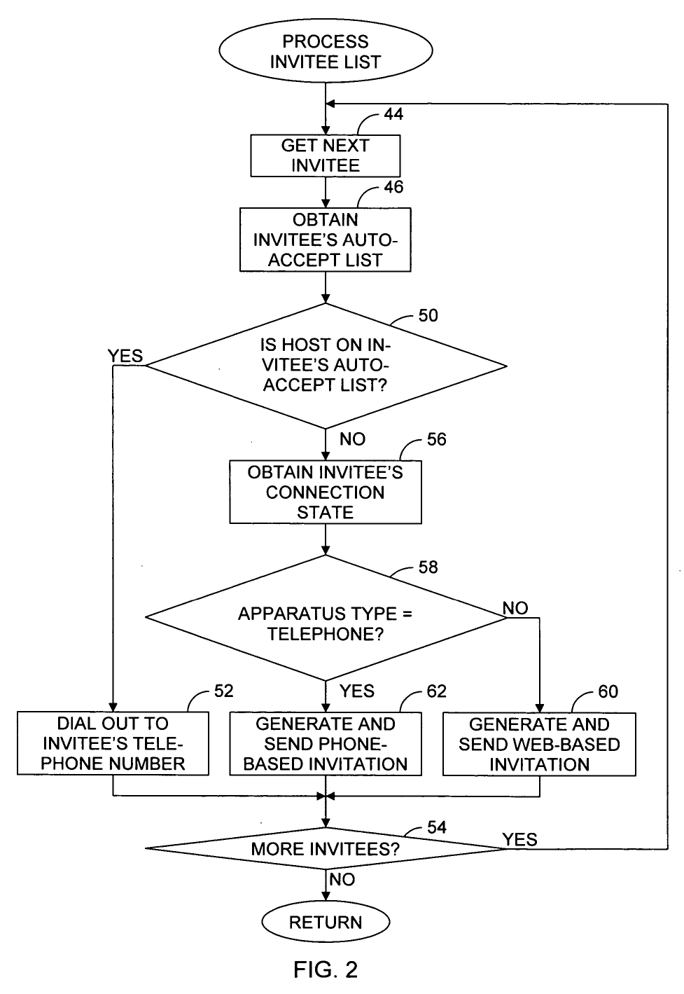

Among the features of some instant-messaging services is that they are often apprised of the type of apparatus to which the instant message is delivered. For example, many instant messages are delivered to IM-enabled telephones (typically mobile phones) rather than to desktop or laptop workstations. The instant-messaging service may make that apparatus-type information available to other subscribers or network services, such as the conference-calling system. If the instant-messaging service thus makes an invitee's apparatus-type information available, some embodiments will use that information to change the manner in which they extend the conference invitation. Such an embodiment may, for example, process invitee lists in accordance with a routine of which FIG. 2 is a simplified flow chart.

In that flow chart, block 44 indicates that the conference-calling system loops through the indicated operations once for each listed invitee. For the sake of example, we assume here that the invitee list includes only the invitees who are currently on line. We will also assume that the embodiment is of the type that maintains auto-accept lists, so block 46 represents fetching that list from storage circuitry 48 (FIG. 1) that in the illustrated embodiment is accessible to the server circuitry and the bridge circuitry both. As FIG. 2's block 50 indicates, the conference-calling system therefore determines whether the auto-accept list maintained for the conference host includes a (telephone-number-containing) entry for the current invitee. If it does, the conference center simply connects the invitee into the conference by using that number, as block 52 indicates, and it proceeds to the next invitee if a determination represented by block 54 indicates that any remain in the list. For the sake of simplicity, the drawing does not show the possibility of sending calls to multiple numbers, but, as was mentioned above, some services may employ that feature. In addition, although the drawing depicts the service as refraining from sending web-page URIs to auto-accept invitees, the service may actually do so to enable the invitee to “re-accept” at a telephone number not previously provided.

If the conference host is not on the invitee's auto-accept list, the conference-calling system determines which mode to use in extending an invitation to the current invitee. In the illustrated embodiment, part of the information that the conference host's web browser sends the conference-calling system is an indication of whether the invitee is using a telephone to receive his instant messages, and blocks 56 and 58 represent retrieving that information and branching on the result. If the invitee is not using a telephone for his instant messages, the conference-calling center causes a web-based invitation to be sent, as block 60 indicates. As was explained above, that is, it provides the conference host a conferencing client, and the conferencing client causes the host's instant-messaging client to send the invitee a telephone-number-eliciting web page's URI. (Actually, the URI specifies a file for creating web pages dynamically and passes parameters that will result in its dynamically generating an invitee-specific web page.) Of course, the conferencing system need not use instant messaging to send the URI; it can use protocols such as SMS, WAP Push, and SMTP, for example.

If the block-58 operation finds that the invitee is indeed using a telephone to receive instant messages, the programming sent to the conference host's browser causes his instant-messaging client to send the invitation to the invitee's IM-enabled phone, as block 62 indicates. In this case, the invitation typically takes the form of a text message that includes the appropriate conference-bridge telephone number. In the illustrated embodiment, the message also includes a code such as a personal-identification number (“PIN”). In response to the invitee's making a call to the received telephone number and supplying the PIN, the system admits the invitee to the conference. The PIN is unique among all other PINs similarly used to gain access to the conference, so it provides an automated way to identify the user to the system. It may further uniquely identify the combination of invitee and conference among all combinations of current invitees and conferences. Among its possible uses is to enable the system to generate a conference-status display that tells the conference host and/or others who is currently in the conference.

Having thus processed the invitee list, the conference-calling system initiates the conference in the manner mentioned above. It causes one of its conference bridges to send calls to the collected telephone numbers and/or receive and validate calls from invitees who called in from phones, and it joins into the conference the invitees who thereby accept their invitations.

From the foregoing description, it is apparent that the invention enables a conference host to initiate a telephone conference in a particularly simple manner. In some embodiments, the host will simply direct his browser to the service's web site, indicate through the site that he wants to start a conference, select invitees by selecting from a list of potential invitees thereby presented to him, and answer his telephone to join the conference. The present invention therefore constitutes a significant advance in the art.

1. A conference-call apparatus comprising:
A) a web server;
B) a conference bridge; and
C) control circuitry for responding to a request from a conference host for a conference call by:
i) operating the web server to provide at least one telephone-number-eliciting web page;
ii) sending to at least one invitee a message inviting that invitee to direct a browser to one said telephone-number-eliciting web page;
iii) operating the web server to obtain a telephone number thereby elicited from the invitee; and
iv) operating the conference bridge to join the invitee to the conference call by sending a telephone call to that telephone number.

2. A conference-calling apparatus as defined in claim 1 wherein the message inviting that invitee to direct a browser to one said telephone-number-eliciting web page includes that web page's URI.

3. A conference-calling apparatus as defined in claim 1 wherein the control circuitry additionally:
A) retrieves an auto-accept list maintained for an invitee;
B) determines whether the conference host is listed in an auto-accept list maintained for an invitee; and
C) if the conference host is thereby determined to be listed in that auto-accept list and the invitee does not supply a telephone number through a telephone-number-eliciting web page:
i) retrieves a telephone number that, before the request from the conference host for the conference call, was stored for that invitee; and
ii) operates the conference bridge to join the invitee to the conference call by sending a telephone call to that telephone number.

4. A conference-call apparatus as defined in claim 3 wherein, if the control circuitry determines that the conference host is listed in the auto-accept list maintained for the invitee, the control circuitry refrains from sending that invitee a message that invites the invitee to direct a browser to any said telephone-number-eliciting web page.

5. A conference-call apparatus as defined in claim 1 wherein the telephone call sent by the conference bridge is a PSTN call.

6. A conference-call apparatus as defined in claim 1 wherein the telephone call sent by the conference bridge is a VoIP call.

7. A conference-call apparatus as defined in claim 1 wherein the invitee has an instant-messaging client and the control circuitry sends the invitee's instant-messaging client the message inviting the invitee to direct the browser to said one telephone-number-eliciting web page.

8. A conference-call apparatus as defined in claim 7 wherein the conference host has an instant-messaging client and the control circuitry causes the conference host's instant-messaging client to send the invitee's instant-messaging client the message inviting the invitee to direct the browser to said one telephone-number-eliciting web page.

9. A conference-call apparatus as defined in claim 1 wherein the control circuitry employs SMS to send the invitee the message inviting the invitee to direct the browser to said one telephone-number-eliciting web page.

10. A conference-call apparatus as defined in claim 1 wherein the control circuitry employs SMTP to send the invitee the message inviting the invitee to direct the browser to said one telephone-number-eliciting web page.

11. A conference-call apparatus as defined in claim 1 wherein the control circuitry employs WAP Push to send the invitee the message inviting the invitee to direct the browser to said one telephone-number-eliciting web page.

12. A conference-call apparatus as defined in claim 1 wherein the control circuitry:
A) obtains from a presence network apparatus-type information concerning a conference invitee;
B) determines from the apparatus-type information thereby obtained whether the invitee is employing a telephone to receive messages;
C) if the invitee is thereby determined to be employing a telephone to receive messages, sending the invitee a telephone number to call in order to join the conference call.

13. A conference-call apparatus comprising:
A) a web server;
B) a conference bridge; and
C) control circuitry for responding to a request from a conference host for a conference call by:
i) obtaining from a presence network apparatus-type information concerning a conference invitee;
ii) determining from the apparatus-type information thereby obtained whether the invitee is employing a telephone to receive messages;
iii) if the invitee is thereby determined to be employing a telephone to receive messages, sending the invitee a telephone number to call in order to join the conference call; and
iv) if the invitee is online but not thereby determined to be employing a telephone to receive messages:
a) eliciting from the invitee a telephone number at which that invitee can be reached; and
b) operating the conference bridge to join the invitee to the conference call by sending a call to that telephone number.

14. A conference-call apparatus as defined in claim 13 wherein the telephone number sent to the invitee is accompanied by a code number that uniquely identifies that invitee among all invitees to the conference.

15. A conference-call apparatus as defined in claim 14 wherein the telephone number sent to the invitee is accompanied by a code number that uniquely identifies that invitee and the conference among all invitees and current conferences.

16. For operating a conference-call apparatus comprising a web server and a conference bridge to respond to a request for a conference call, a method comprising:
A) operating the web server to provide at least one telephone-number-eliciting web page;
B) sending to at least one invitee a message inviting that invitee to direct a browser to one said telephone-number-eliciting web page;
C) operating the web server to obtain a telephone number thereby elicited from the invitee; and
D) operating the conference bridge to join the invitee to the conference call by sending a telephone call to that telephone number.

17. For operating a conference-call apparatus comprising a web server and a conference bridge to respond to a request for a conference call, a method comprising:
A) obtaining from a presence network apparatus-type information concerning a conference invitee;
B) determining from the apparatus-type information thereby obtained whether the invitee is employing a telephone to receive messages;
C) if the invitee is thereby determined to be employing a telephone to receive messages, sending the invitee a telephone number to call in order to join the conference call; and
D) if the invitee is online but not thereby determined to be employing a telephone to receive messages:
i) eliciting from the invitee a telephone number at which that invitee can be reached; and
ii) operating the conference bridge to join the invitee to the conference call by sending a call to that telephone number.

18. A storage medium containing instructions readable by a computer system to configure the computer system as control circuitry for responding to a conference-call request from a conference host to a conference-call apparatus comprising a web server and a conference bridge by:
A) operating the web server to provide at least one telephone-number-eliciting web page;
B) sending to at least one invitee a message inviting that invitee to direct a browser to one said telephone-number-eliciting web page;
C) operating the web server to obtain a telephone number thereby elicited from the invitee; and
D) operating the conference bridge to join the invitee to the conference call by sending a telephone call to that telephone number.

19. A storage medium containing instructions readable by a computer system to configure the computer system as control circuitry for responding to a conference-call request from a conference host to a conference-call apparatus comprising a web server and a conference bridge by:
A) obtaining from a presence network apparatus-type information concerning a conference invitee;
B) determining from the apparatus-type information thereby obtained whether the invitee is employing a telephone to receive messages;
C) if the invitee is thereby determined to be employing a telephone to receive messages, sending the invitee a telephone number to call in order to join the conference call; and
D) if the invitee is online but not thereby determined to be employing a telephone to receive messages:
i) eliciting from the invitee a telephone number at which that invitee can be reached; and
ii) operating the conference bridge to join the invitee to the conference call by sending a call to that telephone number.
